(19) United States
(12) Patent Application Publication
(10) Pub. No.: US 2014/0357355 A1
(43) Pub. Date: Dec. 4, 2014

(54) APPARATUSES AND METHODS FOR PREVENTING GAME CHEATING BY PLUG-INS

(71) Applicant: Tencent Technology (Shenzhen) Company Limited, Shenzhen (CN)

(72) Inventors: Jiaojiao REN, Shenzhen (CN); Xiaowei FENG, Shenzhen (CN); Yan XIONG, Shenzhen (CN)

(21) Appl. No.: 14/315,829

(22) Filed: Jun. 26, 2014

Related U.S. Application Data
(63) Continuation of application No. PCT/CN2014/071305, filed on Jan. 24, 2014.

(30) Foreign Application Priority Data
Jun. 3, 2013 (CN) 201310216155.4

(51) Int. Cl. A63F 13/30

(52) U.S. Cl. CPC A63F 13/12; A63F 2300/5586
USPC 463/29

(57) ABSTRACT

A method for preventing game cheating may comprise acquiring a database associated with an online service, including feature data associated with a plurality of features; and for each of the plurality of features, generating a cheating probability distribution, based on the feature data, associates a value of the feature with a probability that a user account having a same feature value belongs to a cheating user. Further, the method may comprise receiving feature data of a current user account of the online service; determining whether the current user account belongs to a cheating user; and if yes, prohibiting the current user account from accessing the online service.

### PRIORITY STATEMENT

This application is a continuation of International Application No. PCT/CN2014/071305, filed on Jan. 24, 2014, in the State Intellectual Property Office of the People's Republic of China, which claims the benefit of Chinese Patent Application No. 2013102161554 filed on Jun. 3, 2013, the disclosures of which are incorporated herein in their entirety by reference.

### BACKGROUND

1. Field of the Invention

The present disclosure relates to Internet technology. Specifically, the present disclosure relates to methods and apparatuses for preventing game cheating by plug-in.

2. Background

Online game, also called Web game, is a kind of game running over Internet, which may be logged in and played by a user using a client device with a Web Browser. A user may play the game at anywhere, any place, and on any client device with Internet access, such as a personal computer (PC), as long as the user is able to log in the Internet Explorer in the client device.

With the continuing development of the online games, the technologies of cheating plug-ins (e.g., plug-ins and/or patches) are also developing correspondingly. The cheating plug-ins impact seriously the legitimate interests of the game development companies and the game users. The cheating plug-in refers to a kind of cheating program for one or several specific online games built by someone with his/her computer technologies, which may change part of the programs of the online game software, impersonate a legitimate user to send the requests to the server for the game resources and acquire the game resources.

Normal, legitimate game users need to send request for acquiring the game resources to the server via the client device when playing online games, which will not impact the power consumption, or the workload, of a server heavily. But, a plug-in is an illegal usage that “refreshing the server” too frequently through automatic actions from a machine/client device, i.e., cheating plug-ins impersonates a legitimate user and keeps sending requests to the server for the game resources and acquire the game resources, resulting an increase of power consumption of the server (i.e., generating a heavy work load to the server). Refreshing the server not only occupies the upstream and/or the downstream interaction of the whole system, but also brings the unnecessary extra power consumption to the server.

### SUMMARY

According to an aspect of the present disclosure, a method for preventing game cheating may comprise acquiring a database associated with an online service, including feature data associated with a plurality of features; and for each of the plurality of features, generating a cheating probability distribution, based on the feature data, that associates a value of the feature with a probability that a user account having a same feature value belongs to a cheating user. Further, the method may comprise receiving feature data of a current user account of the online service; determining whether the current user account belongs to a cheating user; and if yes, prohibiting the current user account from accessing the online service.

According to another aspect of the present disclosure, an apparatus may comprise at least one processor-readable non-statutory storage medium and at least one processor in communication with the at least one storage medium. The at least one storage medium may comprise a plurality of module, wherein each module comprises at least one set of instructions for preventing game cheating. The at least one processor may be configured to execute the at least one set of instructions to acquire a database associated with an online service, including feature data associated with a plurality of features; and for each of the plurality of features, generate a cheating probability distribution, based on the feature data, that associates a value of the feature with a probability that a user account having a same feature value belongs to a cheating user. Further, the at least one processor may be configured to execute the at least one set of instructions to receive feature data of a current user account of the online service; determine whether the current user account belongs to a cheating user; and if yes, prohibit the current user account from accessing the online service.

According to yet another aspect of the present disclosure, a non-statutory processor-readable storage medium may comprise at least one set of instructions for preventing game cheating. The at least one set of instructions may be configured to direct at least one processor to perform acts of acquiring a database associated with an online service, including feature data associated with a plurality of features; and for each of the plurality of features, generating a cheating probability distribution, based on the feature data, that associates a value of the feature with a probability that a user account having a same feature value belongs to a cheating user. Further, the at least one set of instructions may be configured to direct the at least one processor to perform acts of receiving feature data of a current user account of the online service; determining whether the current user account belongs to a cheating user; and if yes, prohibiting the current user account from accessing the online service.

### BRIEF DESCRIPTION OF THE DRAWINGS

The above and other features and advantages will become more apparent by describing in detail example embodiments thereof with reference to the attached drawings in which:

The above and other features and advantages will become more apparent by describing in detail example embodiments thereof with reference to the attached drawings in which:

FIG. 1 is a process flow diagram illustrating a method for preventing game cheating by plug-ins, according to example embodiments of the present disclosure;

FIG. 2 is a process flow diagram illustrating a method for preventing game cheating by plug-ins, according to the example embodiments of the present disclosure;

FIG. 3 is a process diagram illustrating Step S22 in FIG. 2;

FIG. 4 is a schematic diagram illustrating an apparatus for preventing game cheating by plug-ins, according to the example embodiments of the present disclosure;

FIG. 5 is a structured schematic diagram of the apparatus for preventing game cheating plug-ins, according to the example embodiments of the present disclosure;

FIG. 6 is a schematic diagram illustrating an example embodiment of a server; and

FIG. 7 is a schematic diagram illustrating an example embodiment of a client device in the present disclosure.

### DETAILED DESCRIPTION

Example embodiments will now be described more fully with reference to the accompanying drawings, in which the example embodiments are shown. The example embodiments may, however, be embodied in many different forms and should not be construed as being limited to the example embodiments set forth herein; rather, the example embodiments are provided so that this disclosure will be thorough and complete, and will fully convey the concept of the invention to one skilled in the art. The drawings may be exaggerated for clarity and not necessarily in scale. Like reference numerals in the drawings denote like elements, and thus, their description will not be repeated.

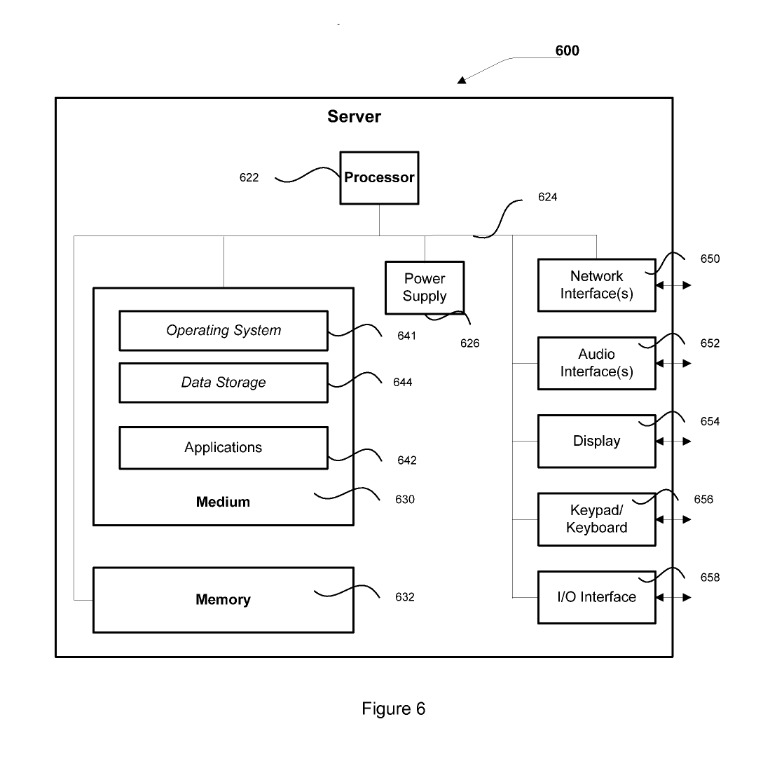

FIG. 6 is a schematic diagram illustrating an example embodiment of a server. The server 600 may connect to a client device locally or via a network. A server 600 may vary widely in configuration or capabilities, it may also include one or more central processing units 622 (i.e., processor) and memory 632, one or more medium 630 (such as one or more mass storage devices) storing application programs 642 or data 644, one or more power supplies 626, one or more wired or wireless network interfaces 650, one or more input/output interfaces 658, and/or one or more operating systems 641, such as Windows Server™, Mac OS X™, Unix™, Linux™, FreeBSD™. Thus a server 600 may include, as examples, dedicated rack-mounted servers, desktop computers, laptop computers, set top boxes, mobile computational devices such as smart phones, integrated devices combining various features, such as two or more features of the foregoing devices.

The server 600 may serve as a search server 106 or a content server 107. A content server 107 may include a device that may include a configuration to provide content via a network to another device. A content server may, for example, host a site, such as a social networking site, examples of which may include, but are not limited to, Flicker™, Twitter™, Facebook™, LinkedIn™, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that may include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server may include desktop computers, multiprocessor systems, microprocessor type or programmable consumer electronics, etc.

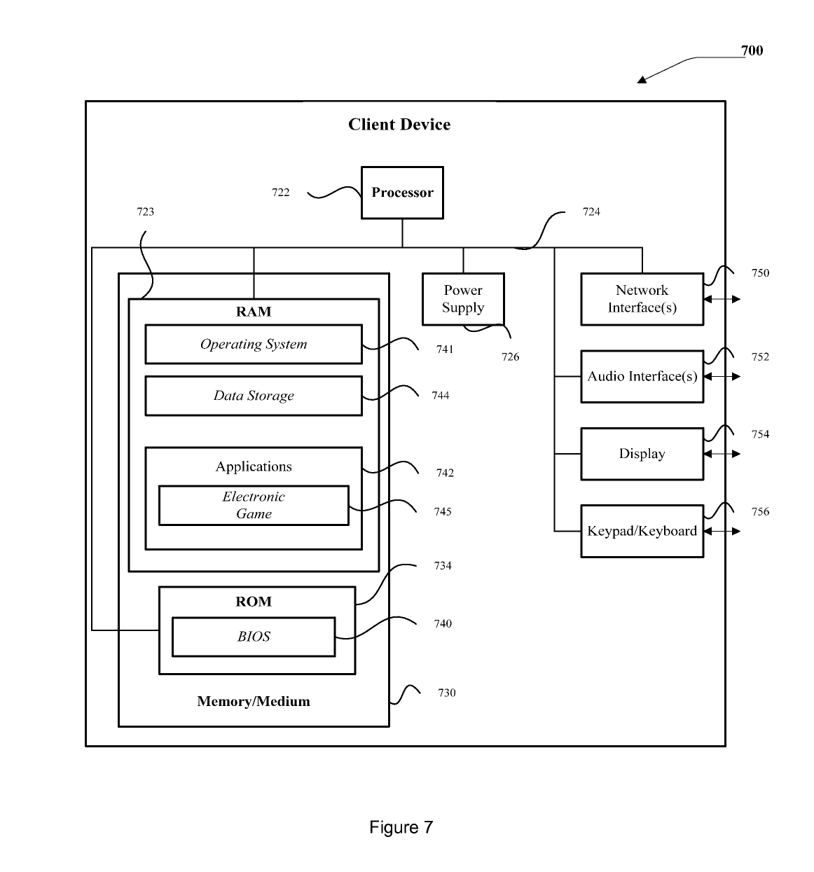

FIG. 7 is a schematic diagram illustrating an example embodiment of a client device as introduced in the present disclosure. The client device may include apparatuses to execute methods and software systems introduced in the present disclosure. A client device 700 may be a computing device capable of executing a software system. The client device 700 may, for example, be a device such as a personal desktop computer or a portable device, such as a laptop computer, a tablet computer, a cellular telephone, or a smart phone.

The client device 700 may vary in terms of capabilities or features. Claimed subject matter is intended to cover a wide range of potential variations. For example, the client device 700 may include a keypad/keyboard 756. It may also may include a display 754, such as a liquid crystal display (LCD), or a display with a high degree of functionality, such as a touch-sensitive color 2D or 3D display. In contrast, however, as another example, a web-enabled client device 700 may include one or more physical or virtual keyboards, and mass storage medium 730.

The client device 700 may also include or may execute a variety of operating systems 741, including an operating system, such as a Windows™ or Linux™, or a mobile operating system, such as iOS™, Android™, or Windows Mobile™. The client device 700 may include or may execute a variety of possible applications 742, such as an electronic game 745. An application 742 may enable communication with other devices via a network, such as communicating with another computer via a network for online content browsing.

Further, the client device 700 may include one or more non-transitory processor-readable storage media 730 and one or more processors 722 in communication with the non-transitory processor-readable storage media 730. For example, the non-transitory processor-readable storage media 730 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 730 may store sets of instructions, or units and/or modules that may include the sets of instructions, for conducting operations and/or method steps described in the present disclosure. Alternatively, the units and/or modules may be hardware disposed in the client device 700 configured to conduct operations and/or method steps described in the present disclosure. The one or more processors may be configured to execute the sets of instructions and perform the operations in example embodiments of the present disclosure.

Merely for illustration, only one processor will be described in client devices that execute operations and/or method steps in the following example embodiments. However, it should be note that the client devices in the present disclosure may also may include multiple processors, thus operations and/or method steps that are performed by one processor as described in the present disclosure may also be jointly or separately performed by the multiple processors. For example, if in the present disclosure a processor of a client device executes both step A and step B, it should be understood that step A and step B may also be performed by two different processors jointly or separately in the client device (e.g., the first processor executes step A and the second processor executes step B, or the first and second processors jointly execute steps A and B).

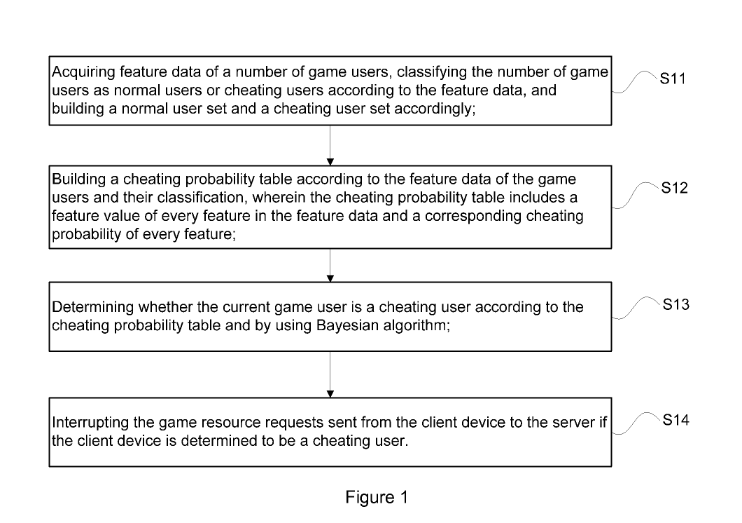

FIG. 1 is a process flow diagram illustrating a method for preventing game cheating plug-ins according to example embodiments of the present disclosure. The method may be implemented in and executed by a computerized device, such the server 600 (or the client device 700), to perform the acts of:

Step S11: Acquiring feature data of a number of game users, classifying the number of game users as normal users or cheating users according to the feature data, and building a normal user set and a cheating user set accordingly.

In this step, the server may acquire a database associated with an online service, such as the online game, from user accounts (hereinafter “users”) that belong to users of the online service. The users may be game users of a particular online game. They may include legitimate users, which may be a true player or normal users of the online game, and cheating users, which may be a cheating plug-in impersonated as a legitimate user. Both the legitimate users and the cheating users may send requests to a server of a game to get game sources through their respective client device and then start to play the game. The server may be the server 600 in FIG. 6 and the client device may be the client device 700 in FIG. 7. When a user is playing the game over the Internet, actions and/or operations of each game user may be logged and/or as corresponding operating records in the background system of the client device.

The feature data of the legitimate users and cheating users may be data collect from real game users of the online game during a period of time. For example, the feature data may be acquired and/or obtained by collecting and operating records of a number of game users randomly.

The feature data may include role levels (e.g., performance level of roles in the online game), number of the role, Recharged Amount (e.g., the amount of money in an account), Payment Amount (or Consumption Amount) and other data of features. For example, the Payment Amount may be an amount of money consumed by playing the online game, such as buying weapons or tools for roles in the game. The Recharged Amount may be an amount of money saved in an account of a user. Normally the money in a legitimate account is recharged and/or saved by its user. But because a cheating account may use a machine to operate a role of the game and illegally use the game resources to earn weapons or tools, the money may be obtained by selling the tools or weapons to other legitimate accounts in the online game, which is prohibited.

The database may include a legitimate data category and a cheating data category, each including feature data associated with a plurality of features. For example, the number of game users may be manually classified as normal (or legitimate) users or cheating users according to the feature data, and build a corresponding normal user set and/or category and a cheating user set and/or category. The normal (i.e., legitimate) user set/category may serve as a training sample set, which includes feature data obtained from normal legitimate game users, and the cheating user set may server as a training sample data set, which includes feature data obtained from cheating users.

Step S12: Building a cheating probability table according to the feature data of the game users and their classification (legitimate user or cheating user), wherein the cheating probability table may include a feature value of every feature in the feature data and a corresponding cheating probability of every feature.

In this step, the server may calculate the feature value of every feature in the feature data and the corresponding cheating probability score of every feature, i.e. a value that reflects the probability that a feature value is from a cheating user, based on the feature data of the classified users and by using Bayesian algorithm. The server then may build the cheating probability table according to the acquired corresponding cheating probability score of every feature. The Bayesian algorithm is based on the Bayes theorem: a given term is categorized to a category among a number of categories, where the term has the largest probability to appear in that category. The Bayesian algorithm is a “self-learning based” smart technology, which may adapt itself to prevent the new cheating tricks in the online games, and thereby protect the normal users.

Step S13: Determining whether the current game user is a cheating user according to the cheating probability table and by using Bayesian algorithm.

In this step, the server may search the probability score in the cheating probability table that corresponds to the feature data of the current user, and calculate the probability score that the current user being a cheating user by using Bayesian algorithm. The bigger the probability score is, the hither the probability that the current user is a cheating user. For example, if the probability is 1, the user may be determined as a cheating user; if the probability is 0, the user may be determined as a normal user.

Step S14: Interrupting the game resource requests to the server sent from the client device which is determined as a cheating user.

In this step, the server may prohibit the cheating user from accessing any of the online game resources. If the current client device is determined as a cheating user, the game resource requests to the server sent from the client device may be interrupted and the game resource (e.g., online gaming services sent from the server) to the client device from the server may be interrupted. Furthermore, the account number that the cheating user may be configured to log in and play the online game may also be blocked from further playing the same online game. For example, the account number of the cheating user may be permanently closed, or alternatively, the server may refuse to respond to future requests for game resources from the account number of the cheating user.

Accordingly, the above method for preventing game cheating plug-ins may detect the game cheating plug-ins effectively by acquiring the feature data of several game users, classifying the several game users as the legitimate users or the cheating users according to the feature data, building a cheating probability table according to the feature data of the classified users and their classification, determining whether the current game user is a cheating user according to the cheating probability table and by using Bayesian algorithm, and interrupting the game resource requests to the server sent from the client device which is determined as a cheating user, so as to reduce the power consumption or workload of the server, and improve the efficiency of the online game.

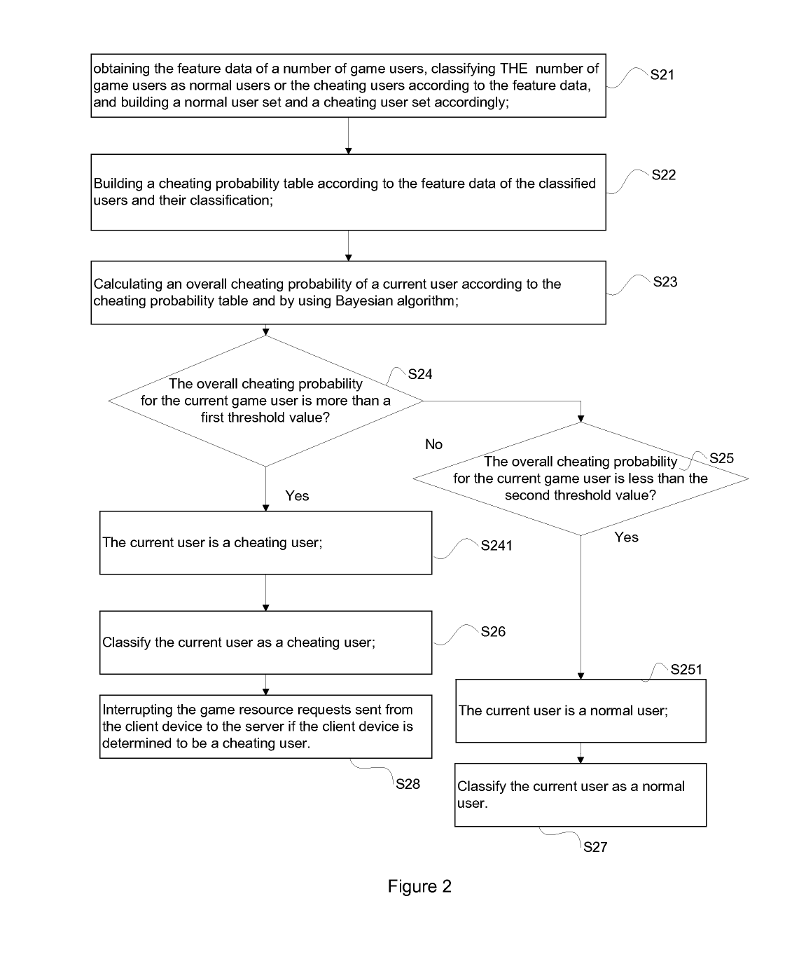

FIG. 2 is a process flow diagram illustrating a method for preventing game cheating plug-ins according to example embodiments of the present disclosure. The method may be implemented in and executed by a computerized device, such the server 600 (or the client device 700), to perform the acts of:

Step S21: acquiring and/or obtaining the feature data of a number of game users (e.g., from client devices of the respective game users), classifying the number of game users as normal users (e.g., legitimate users) or the cheating users according to the feature data, and building a normal user set and a cheating user set accordingly.

According to the example embodiments of the present disclosure, the server may acquire and/or obtain the feature data of a number of game users, and then the game users (or the client devices of the game users) may be manually classified as the normal users (i.e., legitimate users) or the cheating users, and then the server may build a normal user set Z and the cheating user set W accordingly (i.e., a set including the normal user and a set including the cheating user), wherein the normal user set Z corresponds to the normal users and the cheating user set W corresponds to the cheating users.

For example, assuming that the server collects feature data of four users, for each user the features in feature data collected may include Highest Role Level, Recharge Amount, Number of Roles, these feature data may be manually classified as either cheating users or normal users, based on the feature data and empirical data. Table 1 shows the feature data of each user and the corresponding classification.

TABLE 1

| | | Number | |
|---|---|---|---|
| Highest Role Level | Recharge Amount | of Roles | Classification |
| 1 | 0 | 30 | Cheating User |
| 92 | 20000 | 10 | Normal User |
| 20 | 0 | 1 | Normal User |
| 20 | 0 | 40 | Cheating User |

Step S22: Building a cheating probability table according to the feature data of the classified users and their classification, wherein the cheating probability table may include a feature value of every feature in the feature data and the corresponding cheating probability of every feature.

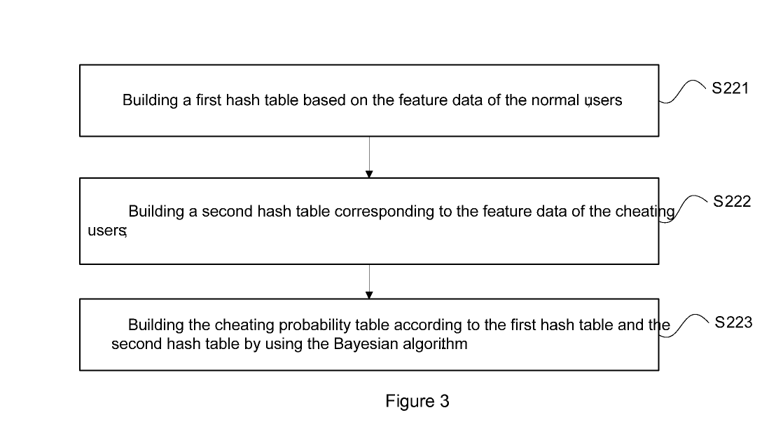

In this step, the server may generate a cheating probability distribution based on the feature data in the legitimate data category and the feature data in the cheating data category. Referring to the FIG. 3, the step S22 may further include:

Step S221: Building a first hash table (Table 2) based on the feature data of the normal users shown in Table 1. The hash table (i.e., hash map) may be a data structure that maps the features to values. The first hash table may include the feature value of every feature in the feature data of the normal users, and the corresponding occurrence frequency and occurrence probability of every feature value based on the data provided in Table 1.

Table 2 is the first hash table hashtable_z built according to the feature data corresponding to the normal users in the Table 1. The first hash table hashtable_z may associate a value of the feature in the legitimate data category with a probability that a legitimate user having the feature with the value.

For example, the first hash table hashtable_z may correspond to the feature data of the normal users, wherein the first hash table hashtable_z may include the feature value of every feature in the feature data of the normal user set Z, and the corresponding occurrence frequency and occurrence probability p(ti|Z) of every feature value, wherein ti refers to a feature.

The occurrence frequency may refer to the number of times that the feature value appears in the table. For example, for the feature “Highest Role Level,” the value 20 occurs twice. One corresponds with a normal user and the other corresponds with a cheating user. Thus for the first hash table hashtable_z, which is a table for normal user, the occurrence frequency is 1. The occurrence probability p(ti|Z) may refer to the probability that the value of a feature is the value shown in the hashtable_z. For example, there are only 2 normal users in Table 1, and the corresponding values for the “Highest Role Level” are 20 and 92, respectively. Thus under the database shown in Table 1, the probability that a normal user has a Highest Role Level value of 20 is 50%, and the probability that a normal user has a Highest Role Level value of 92 is 50%. Under the database, the probability that the value of the feature “Highest Role Level” is other than 20 and 92 is 0%.

The occurrence probability p(ti|Z) may be calculated according to a formula of:

p(ti|Z)=(The occurrence frequency of a feature)/the length of the corresponding hash table).

TABLE 2
The first hash table hashtable_z

| | | Occurrence | Occurrence |
|---|---|---|---|
| Feature | Feature Value | Frequency | Probability |
| Highest Role Level | 20 | 1 | 0.5 |
| | 92 | 1 | 0.5 |
| Recharge Amount | 0 | 1 | 0.5 |
| | 20000 | 1 | 0.5 |
| Number of Roles | 1 | 1 | 0.5 |
| | 10 | 1 | 0.5 |

Step S222: Building a second hash table (Table 3) corresponding to the feature data of the cheating users, wherein the second hash table may include the feature value of every feature in the feature data of the cheating users as well as the corresponding occurrence frequency and occurrence probability of every feature value based on the data provided in Table 1.

Table 3 is the second hash table hashtable_w built according to the feature data corresponding to the cheating users in the Table 1. The second hash table hashitable_w may associate a value of the feature in the cheating data category with a probability that a cheating user account having the feature with the value.

For example, the second hash table hashtable_w may include the feature value of every feature in the feature data of the cheating user set W, and the corresponding occurrence frequency and occurrence probability p(ti|W) of every feature value.

The occurrence probability p(ti|W) may be calculated according to a formula of:

p(ti|W)=(The occurrence frequency of a feature)/The length of the corresponding hash table).

TABLE 3
The second hash table hashtable_w

| | | Occurrence | Occurrence |
|---|---|---|---|
| Feature | Feature Value | Frequency | Probability |
| Highest Role Level | 1 | 1 | 0.5 |
| | 20 | 1 | 0.5 |
| Recharge Amount | 0 | 2 | 1 |
| Number of Roles | 30 | 1 | 0.5 |
| | 40 | 1 | 0.5 |

Step S223: Building the cheating probability table according to the first hash table and the second hash table by using the Bayesian algorithm.

In this step, the server may calculate a cheating probability distribution for each of the feature. For a feature value, the cheating probability distribution may provide a probability value that a user is a cheating user.

For example, the server may calculate a cheating probability table hashtable_probability for a feature by combining the first hash table hashtable_z with the second hash table hashtable_w corresponding to the feature.

The cheating probability table hashtable_probability may include the feature value of every feature in the feature data and the cheating probability corresponding to every feature: p(W|ti), wherein,

p(W|ti)=p(ti|W)p(W)/[p(ti|W)p(W)+p(ti|Z)p(Z)].

Since the probability p(W) of the user being a cheating user is same as the probability p(Z) being a normal user, so p(W)=p(Z)=0.5. The above formula may also be expressed as:

p(W|ti)=p(ti|W)/[p(ti|W)+p(ti|Z)].

Step S22 may be taken as a learning procedure of normal users and cheating users, by which the cheating probability table is built.

Table 4 is the cheating probability table built according to the first hash table hashtable_z shown in Table 2 and the second hash table hashtable_z shown in Table 3.

TABLE 4
The cheating probability table hashtable_probability

| Feature | Feature Value | Cheating Probability |
|---|---|---|
| Highest Role Level | 1 | 1 |
| | 92 | 0 |
| | 20 | 0.5 |
| Recharge Amount | 0 | 0.667 |
| | 20000 | 0 |
| Number of Roles | 1 | 0 |
| | 10 | 0 |
| | 30 | 1 |
| | 40 | 1 |

Referring back to FIG. 2, the server may further perform the following acts:

Step S23: Calculating an overall cheating probability of a current user according to the cheating probability table (Table 4) and by using Bayesian algorithm. The overall cheating probability may be a value that reflects the probability for a current game user being a cheating user.

In this step, the server may estimate the probability that the current user, i.e., a new user, is a cheating user based on the cheating probability table hashtable_probability. The overall cheating probability may be expressed as:

p(W|t1, t2, . . . , tn)=(p1×p2× . . . ×pi . . . ×pn)/(p1×p2× . . . ×pi . . . ×pn+(1−p1)×(1−p2)× . . . ×(1−pn)).

where Pi=P(Ci|Wj). As a result, the bigger value of p(W|t1, t2, . . . , tn) is, the greater probability for the current user being a cheating user happens.

Table 5 is a table showing the feature data of two current users E1 and E2 in order to illustrate how the cheating probability is determined and/or calculated.

TABLE 5

| Current User | Highest Role Level | Recharge Amount | Number of Roles |
|---|---|---|---|
| E1 | 20 | 0 | 30 |
| E2 | 1 | 10 | 20 |

For example, for user E1, according to Table 4, the value for Highest Role Level is 20, and the corresponding cheating probability is 0.5; the value for Recharge Amount is 0, and the corresponding cheating probability is 0.667; the value for Number of Roles is 30, and the corresponding cheating probability is 1. Based on these cheating probabilities for the features, the server may calculate the overall cheat probability p(E1) for the current user E1 using the formula

p(W|t1, t2, . . . , tn)=(p1×p2× . . . ×pn)/(p1×p2× . . . pn+(1−p1)*(1−p2)× . . . ×(1−pn)).

Thus the probability for User E1 being a cheating user is:

p(E1)=0.5*0.667*1/(0.5*0.667*1+(1−0.5)*(1−0.667)*(1−1))=1.

For user E2, according to Table 4, the value for Highest Role Level is 1, and the corresponding cheating probability is 1; the value Recharge Amount is 10, and there is no corresponding cheating probability in Table 4; and the value for Number of Roles is 20, and there is no corresponding cheating probability in Table 4. Since there are no corresponding cheating probabilities for the Recharge Amount and Number of Roles in Table 4, the server may designate a value of 0 to them. Accordingly, the overall cheating probability p(E2) for the current user E2, using the formula

p(W|t1, t2, . . . , tn)=(p1*p2* . . . *pn)/(p1*p2* . . . pn+(1−p1)*(1−p2)* . . . *(1−pn)),

is

p(E2)=1*0*0=0.

Step S24: Determining if the overall cheating probability for the current game user is more than a first threshold value. If yes, determining the current user is a cheating user, S241, otherwise, executing Step S25.

In This step, the server may preset a first threshold value T1 and a second threshold value T2, wherein, The value of T1 and T2 is greater than or equal 1, and T1≧T2.

Taking the user E1 and E2 as examples, and assume that T1 is 0.8, the server may determine the user E1 is a cheating user because p(E1)=1>0.8; the server may determine that the user E1 is not a cheating user because p(E2)=0<0.8.

Step S25: Determining if the overall cheating probability for the current game user is less than the second threshold value. If yes, determining the current user is a normal user, S251.

For example, if T2=0.2, the server may determine that the user E2 as a normal user because p(E2)=0<0.2.

Once the current user is determined as a cheating user through Step S24, the server may execute Step S26 to classify the current user as a cheating user and add it into a cheating user set, so as to extend the training sample set of cheating users.

Once the current user is determined as a normal user through Step S25, the server may execute Step S27 to classify the current user as a normal user and add it into a normal user set, so as to extend the training sample set of normal users.

Step S28: Interrupting the game resource requests to the server sent from the client device when the client device is determined as a cheating user.

The method for preventing game cheating plug-ins provided by the embodiment of the present disclosure may detect the game cheating plug-ins effectively by acquiring the feature data of several game users, classifying the several game users as the normal users or the cheating users according to the feature data, by building a cheating probability table according to the feature data of the classified users and their classification, by determining whether the current game user is a cheating user according to the cheating probability table and by using Bayesian algorithm, and by interrupting the game resource requests to the server sent from the client device which is determined as a cheating user.

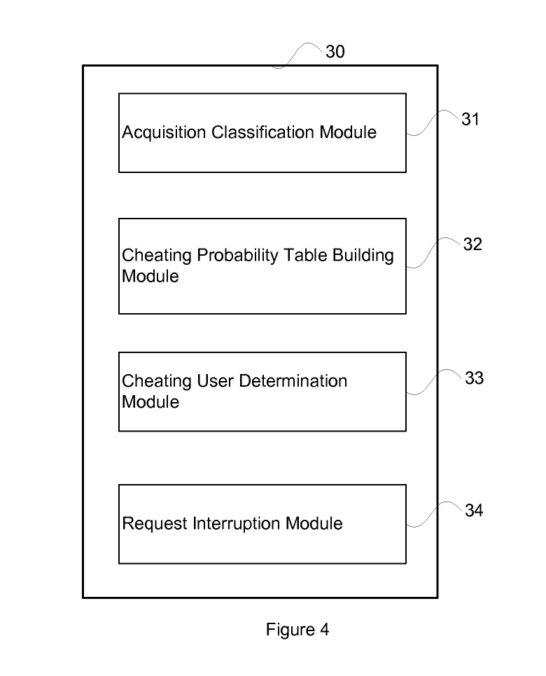

FIG. 4 is a schematic diagram illustrating an apparatus for preventing game cheating plug-ins according to example embodiments of the present disclosure. The apparatus may be the server 600 in FIG. 6 and/or the client device 700 in FIG. 7, and may implement the methods for preventing game cheating plug-ins provided in the example embodiments of the present disclosure. As shown in FIG. 4, the apparatus 30 may include: an acquisition classification module 31, a cheating probability table building module 32, a cheating user determination module 33, and a request interruption module 34.

The acquisition classification module 31 may be configured to acquire the feature data of several game users, classify the several game users as the normal users or the cheating users according to the feature data, and build a normal user set and a cheating user set accordingly.

The cheating probability table building module 32 may be configured to build a cheating probability table according to the feature data of the classified users and their classification, wherein the cheating probability table may include the feature value of every feature in the feature data and the corresponding cheating probability of every feature.

The cheating user determination module 33 may be configured to determine whether the current game user is a cheating user according to the cheating probability table and by using Bayesian algorithm.

The request interruption module 34 may be configured to interrupt the game resource requests to the server sent from the client device when the client device is determined as a cheating user.

The feature data may include, for example, Role Level, Number of Roles, Recharge Amount, Paid Amount, and skill effect of a role, etc.

The skill effect may refer to skill effect of a role in the game to be tested. Feature date of the skill effect of the role to be tested may include, but not limited to, data of damaging level of a skill, effects of additional skills, parameters of equipment, the best distance for a skill to cast, and status of a key skill.

Accordingly, the above apparatus for preventing game cheating plug-ins may prevent the game cheating plug-ins effectively by acquiring the feature data of several game users, classifying the several game users as the normal users or the cheating users according to the feature data, building a cheating probability table according to the feature data of the classified users and their classification, determining whether the current game user is a cheating user according to the cheating probability table and by using Bayesian algorithm, and interrupting the game resource requests to the server sent from the client device when the client device is determined as a cheating user.

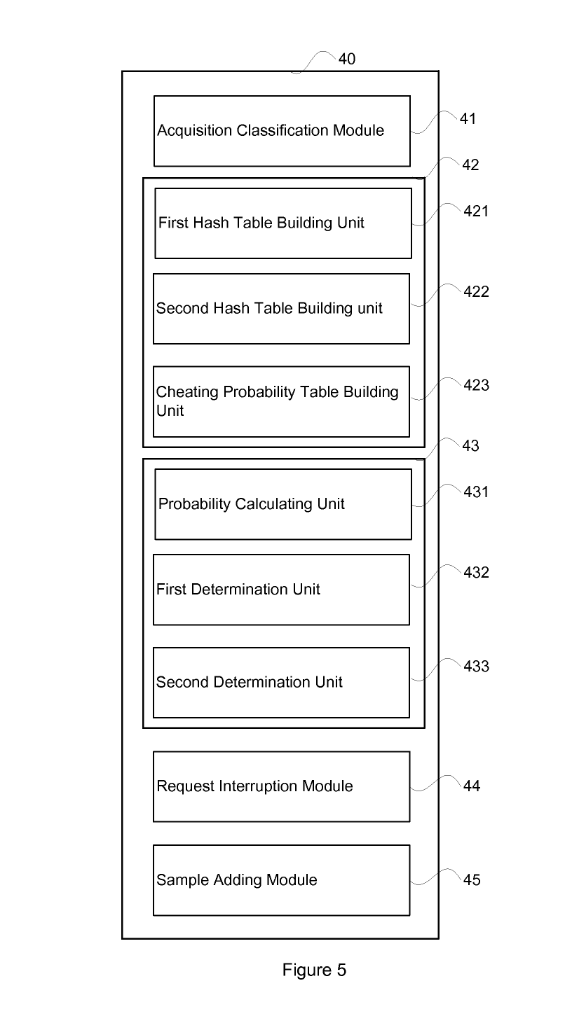

FIG. 5 is a schematic diagram illustrating an apparatus for preventing game cheating plug-ins. The apparatus may be the server 600 and/or the client device 700, and may be implemented to execute the methods disclosed in the present disclosure, such as in the method shown in FIG. 2. As shown in FIG. 5, the apparatus 40 may include: an acquisition classification module 41, a cheating probability table building module 42, a cheating user determination module 43, and a request interruption module 44.

The acquisition classification module 41 may be configured to acquire the feature data of several game users, classify the several game users as the normal users or the cheating users according to the feature data, and build a normal user set and a cheating user set accordingly.

The cheating probability table building module 42 may be configured to build a cheating probability table according to the feature data of the classified users and their classification, wherein the cheating probability table may include the feature value of every feature in the feature data and the corresponding cheating probability of every feature.

The cheating user determination module 43 may be configured to determine whether the current game user is a cheating user according to the cheating probability table and by using Bayesian algorithm. The request interruption module 44 may be configured to interrupt the game resource requests to the server sent from the client device when the client device is determined as a cheating user.

The skill effect data of the role to test may include data of skill damaging level of the role to be test in the game, skill of the additional effects, parameters of the game equipment, the best distance for the skill to cast, and the status of the key skill.

Furthermore, the cheating probability table building module 42 may include: a first hash table building unit 421, a second hash table building unit 422, and a cheating probability table building unit 423.

The first hash table building unit 421 configured to build the first hash table corresponding to the feature data of the normal users. The first hash table may include the feature value of every feature in the feature data of the normal users, and the corresponding occurrence frequency and occurrence probability of every feature value.

The second hash table building unit 422 may be configured to build the second hash table corresponding to the feature data of the cheating users, wherein the second hash table may include the feature value of every feature in the feature data of the cheating users, and the corresponding occurrence frequency and occurrence probability of every feature value.

The cheating probability table building unit 423 may be configured to build the cheating probability table according to the first hash table and the second hash table by using the Bayesian algorithm.

Furthermore, the cheating user determination module 43 may include: a probability calculating unit 431, a first determination unit 432, and a second determination unit 433.

The probability calculation unit 431 may be configured to calculate the probability for the current game user being a cheating user according to the cheating probability table and by using Bayesian algorithm.

The first determination unit 432 may be configured to determine if the probability for the current game user is more than the first threshold value. If yes, the first determination unite 432 may determine that the current user is a cheating user.

The second determination unit 433 may be configured to determine if the probability for the current game user is less than the second threshold value. If yes, the second determination unit 433 may determine that the current user is a normal user.

The apparatus 40 may also include a sample adding module 45. If the current game user is determined to be a cheating user, the sample adding module 45 may classify the current game user as a cheating user and add the user into the cheating user set. If the current game user is determined to be a normal user, the sample adding module 45 may classify the current game user as a normal user and add the user into the normal user set.

The apparatus for preventing game cheating plug-ins provided by the embodiment of the present disclosure may prevent the game cheating plug-ins effectively by acquiring the feature data of several game users, classifying the several game users as the normal users or the cheating users according to the feature data, building a cheating probability table according to the feature data of the classified users and their classification, determining whether the current game user is a cheating user according to the cheating probability table and using Bayesian algorithm, and then interrupting the game resource requests to the server sent from the client device when the client device is determined as a cheating user.

It should be noted that the example embodiments of the present disclosure are described in a progressive manner, wherein the differences of every embodiment with others are highlighted, and features in common or similar between different example embodiments may be cross-referenced with respect to each other.

It should be noted that the relationship terms in this document, such as “the first” threshold value and “the second” threshold value, are used to distinguish an entity or an action from another entity or action. The present disclosure does not intend to require or imply any actual relationships or sequences between these entities and actions. In additional, the term “include”, “may include” or any other variants means the containing not in exclusive, so that the processes, methods, items, or apparatuses, which include a series of elements, can include not only include elements mentioned in the processes, methods, items, or apparatuses, but can also include other elements not listed in the present disclosure, or can also include inherent elements of these processes, methods, items or apparatus. When there are no more restrictions, the elements being restricted by the statement “include . . . ” should not rule out that there are other similar elements exist in the processes, methods, items, or apparatuses which include the elements.

A person of ordinary skill in the art may understand that the realization of all or part of procedures, modules, and/or units may be achieved via hardware or related hardware instructed by programs which may store in one computer readable storage medium that may be a read-only memory, a disk or a CD-ROM etc.

While example embodiments of the present disclosure relate to apparatuses and methods for detecting game cheating plug-ins, the apparatuses and methods may also be applied to other Applications. For example, in addition to online games, the methods and apparatus may also be applied to identification recognition, such as online registration robots, etc. The present disclosure intends to cover the broadest scope of systems and methods for content browsing, generation, and interaction.

Thus, example embodiments illustrated in FIGS. 1-7 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A processor-implemented method for preventing game cheating, the method comprising:
acquiring, by at least one processor, a database associated with an online service,
wherein the database includes a legitimate data category and a cheating data category, each including feature data associated with a plurality of features;
for each of the plurality of features, generating, by at least one processor, a cheating probability distribution based on the feature data in the legitimate data category and the feature data in the cheating data category,
wherein the cheating probability distribution associates a value of the feature with a probability that a user account having a same feature value is a cheating user.

2. The method according to claim 1, wherein
the online service is an online game;
the feature data are collected from a plurality of users accounts of the online service;
the plurality of user accounts includes a plurality of legitimate user accounts and a plurality of cheating user accounts;
each of the plurality of user accounts includes the plurality of features;
the feature data of the plurality of legitimate user accounts are classified under the legitimate data category; and
the feature data of the plurality of cheating user accounts are classified under the cheating data category.

3. The method according to claim 1, further comprising:
receiving, by at least one processor, feature data of the plurality of features associated with a current user account of the online service;
determining, by at least one processor, whether the current user account belongs to a cheating user or a legitimate user based on the feature data of the current user and the cheating probability distributions of the plurality of features; and,
prohibiting, by at least one processor, the current user account from accessing the online service when the current user account belongs to a cheating user.

4. The method according to claim 3, wherein the determining of whether the current user account belongs to a cheating user comprises:
calculating an overall cheating probability for the current user account, taking into account the cheating probability distribution of every one of the plurality of features, by using a Bayesian algorithm;
determining that the current user account belongs to a cheating user when the overall cheating probability is greater than a first threshold; and
determining that the current user account belongs to a legitimate user when the overall cheating probability is lesser than a second threshold.

5. The method according to claim 1, wherein the plurality of features comprises at least one of a Role Level, Number of roles, Recharge Amount, and Payment Amount.

6. The method according to claim 1, wherein the generating of a cheating probability distribution of a feature comprises:
generating a first table associating a value of the feature in the legitimate data category with a first probability that a legitimate user account having the feature with the value;
generating a second table associating a value of the feature in the cheating data category with a second probability that a cheating user account having the feature with the value; and
generating the cheating probability distribution of the feature according to the first table and the second table by using a Bayesian algorithm.

7. The method according to claim 6, wherein:
the generating of the first probability comprises:
calculating a ratio between a frequency that the value appears among all feature data in the legitimate data category with a length of the first table; and
the generating of the second probability comprises:
calculating a ratio between a frequency that the value appears among all feature data in the cheating data category with a length of the second table.

8. The method according to claim 1, further comprising:
adding, by at least one processor, the feature data of the current user account to the cheating data category of the database when the current user account belongs a cheating user; and
add, by at least one processor, the feature data of the current user account to the legitimate data category when the current user account belongs a legitimate user.

9. An apparatus, comprising:
at least one processor-readable non-statutory storage medium comprising a plurality of module, wherein each module comprises at least one set of instructions for preventing game cheating; and
at least one processor in communication with the at least one storage medium configured to execute the at least one set of instructions to:
acquire a database associated with an online service,
wherein the database includes a legitimate data category and a cheating data category, each including feature data associated with a plurality of features;
for each of the plurality of features, generate a cheating probability distribution based on the feature data in the legitimate data category and the feature data in the cheating data category,
wherein the cheating probability distribution associates a value of the feature with a probability that a user account having a same feature value belongs to a cheating user.

10. The apparatus according to claim 9, wherein
the online service is an online game;
the feature data are collected from a plurality of users accounts of the online service;
the plurality of user accounts includes a plurality of legitimate user accounts and a plurality of cheating user accounts;
each of the plurality of user accounts includes the plurality of features;
the feature data of the plurality of legitimate user accounts are classified under the legitimate data category; and
the feature data of the plurality of cheating user accounts are classified under the cheating data category.

11. The apparatus according to claim 1, wherein the at least one processor is further configured to execute the at least one set of instructions to:
receive feature data of the plurality of features associated with a current user account of the online service;
determine whether the current user account belongs to a cheating user or a legitimate user based on the feature data of the current user and the cheating probability distributions of the plurality of features; and,
prohibit the current user account from accessing the online service when the current user account belongs to a cheating user.

12. The apparatus according to claim 11, wherein to determining whether the current user account belongs to a cheating user, the at least one processor is further configured to execute the at least one set of instructions to:
calculate an overall cheating probability for the current user account, taking into account the cheating probability distribution of every one of the plurality of features, by using a Bayesian algorithm;
determine that the current user account belongs to a cheating user when the overall cheating probability is greater than a first threshold; and
determine that the current user account belongs to a legitimate user when the overall cheating probability is lesser than a second threshold.

13. The apparatus according to claim 9, wherein the plurality of features comprises at least one of a Role Level, Number of roles, Recharge Amount, and Payment Amount.

14. The apparatus according to claim 9, wherein to generate a cheating probability distribution of a feature, the at least one processor is further configured to execute the at least one set of instructions to:
generate a first table associating a value of the feature in the legitimate data category with a first probability that a legitimate user account having the feature with the value;
generate a second table associating a value of the feature in the cheating data category with a second probability that a cheating user account having the feature with the value; and
generate the cheating probability distribution of the feature according to the first table and the second table by using a Bayesian algorithm.

15. The apparatus according to claim 14, wherein:
to generate the first probability, the at least one processor is further configured to execute the at least one set of instructions to:
calculate a ratio between a frequency that the value appears among all feature data in the legitimate data category with a length of the first table; and
to generate the second probability, the at least one processor is further configured to execute the at least one set of instructions to:
calculate a ratio between a frequency that the value appears among all feature data in the cheating data category with a length of the second table.

16. A non-statutory processor-readable storage medium comprising at least one set of instructions for preventing game cheating, wherein the at least one set of instructions are configured to direct at least one processor to perform acts of:
acquiring a database associated with an online service,
wherein the database includes a legitimate data category and a cheating data category, each including feature data associated with a plurality of features;
for each of the plurality of features, generating a cheating probability distribution based on the feature data in the legitimate data category and the feature data in the cheating data category,
wherein the cheating probability distribution associates a value of the feature with a probability that a user account having a same feature value belongs to a cheating user.

17. The method according to claim 16, wherein
the online service is an online game;
the feature data are collected from a plurality of users accounts of the online service;
the plurality of user accounts includes a plurality of legitimate user accounts and a plurality of cheating user accounts;
each of the plurality of user accounts includes the plurality of features;
the feature data of the plurality of legitimate user accounts are classified under the legitimate data category; and
the feature data of the plurality of cheating user accounts are classified under the cheating data category.

18. The method according to claim 16, wherein the at least one set of instructions are further configured to direct at least one processor to perform acts of:
receiving feature data of the plurality of features associated with a current user account of the online service;
calculating an overall cheating probability for the current user account, taking into account the cheating probability distribution of every one of the plurality of features, by using a Bayesian algorithm;
determining that the current user account belongs to a cheating user when the overall cheating probability is greater than a first threshold; and
prohibiting the current user account from accessing the online service when the current user account belongs to a cheating user.

19. The method according to claim 16, wherein the generating of a cheating probability distribution of a feature comprises:
generating a first table associating a value of the feature in the legitimate data category with a first probability that the value appears among all feature data in the legitimate data category;
generating a second table associating a value of the feature in the cheating data category with a second probability that the value appears among all feature data in the cheating data category; and
generating the cheating probability distribution of the feature according to the first table and the second table by using a Bayesian algorithm.

20. The method according to claim 19, wherein:
the generating of the first probability comprises:
calculating a ratio between a frequency that the value appears among all feature data in the legitimate data category with a length of the first table; and
the generating of the second probability comprises:
calculating a ratio between a frequency that the value appears among all feature data in the cheating data category with a length of the second table.
